(19) United States
(12) Patent Application Publication
(10) Pub. No.: US 2022/0155455 A1
(43) Pub. Date: May 19, 2022

(54) METHOD AND SYSTEM FOR GROUND SURFACE PROJECTION FOR AUTONOMOUS DRIVING

(71) Applicant: GM GLOBAL TECHNOLOGY OPERATIONS LLC, Detroit, MI (US)

(72) Inventors: Jacqueline Staiger, Upland, CA (US); Hyukseong Kwon, Thousand Oaks, CA (US); Amit Agarwal, Monterey Park, CA (US); Rajan Bhattacharyya, Sherman Oaks, CA (US)

(73) Assignee: GM GLOBAL TECHNOLOGY OPERATIONS LLC, Detroit, MI (US)

(21) Appl. No.: 17/098,702

(22) Filed: Nov. 16, 2020

(51) Int. Cl. G01S 17/931; G06T 7/11; G06T 7/70; G06K 9/00; G01S 17/89; G05D 1/02; B60W 60/00

(52) U.S. Cl. CPC G01S 17/931; G06T 7/11; G06T 7/70; G06K 9/00805; G01S 17/89; G05D 1/0231; B60W 2554/4044; G05D 1/0214; G06T 2207/10028; G06T 2207/30261; B60W 2420/52; B60W 2420/42; B60W 2554/4041; B60W 60/0027

(57) ABSTRACT

A system ground surface projection for autonomous driving of a host vehicle is provided. The system includes a LIDAR device of the host vehicle and a computerized device. The computerized device is operable to monitor data from the LIDAR device including a total point cloud. The total point cloud describes an actual ground surface in the operating environment of the host vehicle. The device is further operable to segment the total point cloud into a plurality of local point cloud and, for each of the local point clouds, determine a local polygon estimating a portion of the actual ground surface. The device is further operable to assemble the local polygons into a total estimated ground surface and navigate the host vehicle based upon the total estimated ground surface.

### INTRODUCTION

The disclosure generally relates to a method and system for ground surface projection for autonomous driving.

Autonomous vehicles and semi-autonomous vehicles utilized sensors to monitor and make determinations about an operating environment of the vehicle. The vehicle may include a computerized device including programming to estimate a road surface and determine locations and trajectories of objects near the vehicle.

### SUMMARY

A system for ground surface projection for autonomous driving of a host vehicle is provided. The system includes a LIDAR device of the host vehicle and a computerized device. The computerized device is operable to monitor data from the LIDAR device including a total point cloud. The total point cloud describes an actual ground surface in the operating environment of the host vehicle. The device is further operable to segment the total point cloud into a plurality of local point clouds and, for each of the local point clouds, determine a local polygon estimating a portion of the actual ground surface. The device is further operable to assemble the local polygons into a total estimated ground surface and navigate the host vehicle based upon the total estimated ground surface.

In some embodiments, the system further includes a camera device of the host vehicle. In some embodiments, the computerized device is further operable to monitor data from the camera device, identify and track an object in an operating environment of the host vehicle based upon the data from the camera device, determine a location of the object upon the total estimated ground surface, and navigate the host vehicle further based upon the location of the object upon the total estimated ground surface.

In some embodiments, the computerized device is further operable to smooth transitions in the total estimated ground surface between the local polygons.

In some embodiments, smoothing the transitions in the total estimated ground surface between the local polygons includes smoothing overlaps in the local polygons.

In some embodiments, smoothing the transitions in the total estimated ground surface between the local polygons includes smoothing gaps in the local polygons.

In some embodiments, the computerized device is further operable to monitor three-dimensional coordinates of the host vehicle, monitor digital map data, and transform the total estimated ground surface into in world coordinates based upon the three-dimensional coordinates and the digital map data.

In some embodiments, determining the local polygon estimating the portion of the actual ground surface includes determining a normal vector angle for each local polygon. In some embodiments, the normal vector angle for each polygon is utilized to map the total estimated ground surface.

According to one alternative embodiment, a system for ground surface projection for autonomous driving of a host vehicle is provided. The system includes a camera device of the host vehicle, a LIDAR device of the host vehicle, and a computerized device. The computerized device is operable to monitor data from the camera device and identify and track an object in an operating environment of the host vehicle based upon the data from the camera device. The computerized device is further operable to monitor data from the LIDAR device including a total point cloud. The total point cloud describes an actual ground surface in the operating environment of the host vehicle. The computerized device is further operable to segment the total point cloud into a plurality of local point clouds and, for each of the local point clouds, determine a local polygon estimating a portion of the actual ground surface. The computerized device is further operable to assemble the local polygons into a total estimated ground surface and determine a location of the object upon the total estimated ground surface. The computerized device is further operable to navigate the host vehicle based upon the total estimated ground surface and the location of the object upon the total estimated ground surface.

In some embodiments, the computerized device is further operable to smooth transitions in the total estimated ground surface between the local polygons.

In some embodiments, smoothing the transitions in the total estimated ground surface between the local polygons includes smoothing overlaps in the local polygons.

In some embodiments, smoothing the transitions in the total estimated ground surface between the local polygons includes smoothing gaps in the local polygons.

According to one alternative embodiment, a method for ground surface projection for autonomous driving of a host vehicle is provided. The method includes, within a computerized processor within the host vehicle, monitoring data from a LIDAR device upon the host vehicle including a total point cloud. The total point cloud describes an actual ground surface in the operating environment of the host vehicle. The method further includes, within the computerized processor, segmenting the total point cloud into a plurality of local point clouds and, for each of the local point clouds, determining a local polygon estimating a portion of the actual ground surface. The method further includes, within the computerized processor, assembling the local polygons into a total estimated ground surface and navigating the host vehicle based upon the total estimated ground surface.

In some embodiments, the method further includes, within the computerized processor, monitoring data from a camera device upon the host vehicle and identifying and tracking an object in an operating environment of the host vehicle based upon the data from the camera device. In some embodiments, the method further includes determining a location of the object upon the total estimated ground surface and navigating the host vehicle further based upon the location of the object upon the total estimated ground surface.

In some embodiments, the method further includes, within the computerized processor, smoothing transitions in the total estimated ground surface between the local polygons.

In some embodiments, smoothing the transitions in the total estimated ground surface between the local polygons includes smoothing overlaps in the local polygons.

In some embodiments, smoothing the transitions in the total estimated ground surface between the local polygons includes smoothing gaps in the local polygons.

In some embodiments, the method further includes, within the computerized processor, monitoring three-dimensional coordinates of the host vehicle, monitoring digital map data, and transforming the total estimated ground surface into in world coordinates based upon the three-dimensional coordinates and the digital map data.

In some embodiments, determining the local polygon estimating the portion of the actual ground surface includes determining a normal vector angle for each local polygon. In some embodiments, the method further includes, within the computerized processor, utilizing the normal vector angle for each polygon to map the total estimated ground surface.

### BRIEF DESCRIPTION OF THE DRAWINGS

FIG. 1 schematically illustrates an exemplary data flow useful to project a ground surface and perform tracking-based state error correction, in accordance with the present disclosure;

FIG. 2 illustrates an exemplary actual ground surface detected by a host vehicle divided into smaller portions, in accordance with the present disclosure;

FIG. 3 illustrates an exemplary cluster of points or a segmented point cloud representing a portion of a global point cloud provided by LIDAR sensor data and illustrates the segmented point cloud being defined as a group to a local polygon, in accordance with the present disclosure;

FIG. 4 illustrates in edge view a first local polygon and a second local polygon, with the two polygons overlapping, in accordance with the present disclosure;

FIG. 5 illustrates in edge view a third local polygon and a fourth local polygon, with the two polygons stopping short of each other with a gap existing therebetween, in accordance with the present disclosure;

FIG. 6 illustrates a plurality of local polygons combined together into a total estimated ground surface, in accordance with the present disclosure;

FIG. 7 graphically illustrates a vehicle pose correction over time, in accordance with the present disclosure;

FIG. 8 schematically illustrates an exemplary host vehicle upon a roadway including the disclosed systems, in accordance with the present disclosure; and

FIG. 9 is a flowchart illustrating an exemplary method for object localization using ground surface projection and tracking-based prediction for autonomous driving, in accordance with the present disclosure.

### DETAILED DESCRIPTION

An autonomous and semi-autonomous host vehicle includes a computerized device operating programming to navigate the vehicle over a road surface, follow traffic rules, and avoid traffic and other objects. The host vehicle may include sensors such as a camera device generating images of an operating environment of the vehicle, a radar and/or a light detection and ranging (LIDAR) device, ultrasonic sensors, and/or other similar sensing devices. Data from the sensors is interpreted, and the computerized device includes programming to estimate a road surface and determine locations and trajectories of objects near the vehicle. Additionally, a digital map database in combination with three-dimensional coordinates may be utilized to estimate a location of the vehicle and surroundings of the vehicle based upon map data.

Three-dimensional coordinates provided by systems such as a global positioning system or by cell phone tower signal triangulation are useful to localizing a vehicle to a location relative to a digital map database within a margin of error. However, three-dimensional coordinates are not exact, with vehicle location predictions based upon three-dimensional coordinates being a meter or more out of position. As a result, a vehicle location prediction may estimate the vehicle to be in mid-air, underground, or half of a lane out of position in relation to the road surface. Ground estimation programming, utilizing sensor data to estimate a ground surface, may be utilized to correct or in coordination with three-dimensional coordinates to increase location prediction of a host vehicle or a neighborhood object in an operating environment of the host vehicle. Such a system may be described as generating an accurate neighborhood objects' pose using a vehicle model along with the ground plane estimation from LIDAR sensor processing.

A method and system is provided to improve detected object localization by generating a ground surface model in order to more accurately determine objects' vertical locations from the ground while also correcting perception-based errors using kinematics-based motion models especially for vehicles.

According to one embodiment, the disclosed method provides more accurate object localization by integrating predictions from kinematics-based motion models with state information generated from ground surface models. The method includes a computationally inexpensive algorithm of ground surface generation from LIDAR sensors. The localization improvements may be targeted toward attaining high fidelity values for object elevations. The disclosed method may generate a robust ground surface even for sparse point clouds.

LIDAR sensor data may be generated and provided including a point cloud, describing LIDAR sensor returns that map a ground surface in an operating environment of the host vehicle. According to one embodiment, a divide-and-conquer approach for the entire point cloud may be applied to efficiently generate non-flat ground surfaces, for example by using a k-d tree method, a computerized method to space-partition data, organizing points in a k-dimensional space. Each segmented point cloud is converted into a plane as a convex polygon, which may include using random sample consensus algorithm (RANSAC) to get rid of outliers. From each convex polygon, the method may acquire a surface normal vector. A surface normal vector angle may be determined as follows.

$$θ = {cos}^{- 1} ( \frac{z}{\sqrt{{x}^{2} + {y}^{2} + {z}^{2}}} ) \qquad ( 1 )$$

θ is a normal vector angle to the determined surface. Normal vector angles are used in three-dimensional graphics to provide shading and textures based upon an orientation of each of the normal vector angles. The normal vector angles provide a computationally inexpensive way to assign graphic values for surface polygons based upon their orientations. In a similar way, a normal vector angle may be applied to each of the local polygons determined by the methods herein, providing a computationally inexpensive method to process, map, and utilize a total estimated ground surface assembled from a sum of the local polygons.

The disclosed method divides a total available point cloud provided by LIDAR sensor data and determines a plurality of local polygons approximating portions of the total available point cloud. Such local polygons may be imperfect, with some local polygons overlapping with neighboring local polygons and with other local polygons ending short of and leaving a gap next to other neighboring local polygons. These local polygons may be integrated into one total estimated ground surface using a surface smoothing algorithm.

Once the global surface is estimated, a tracking-based state error correction may be performed, wherein detected neighborhood objects may be projected upon the estimated global surface. Additionally, a pose of the neighborhood object upon the global surface may be similarly estimated. In one embodiment, a bicycle model, which uses an initial pose of a vehicle and normal constraints on vehicle movement, turning, braking, etc., may be used to predict a trajectory of the vehicle. Such modeling may take into account current and previous/historical values of position, velocity, and acceleration for each object detected.

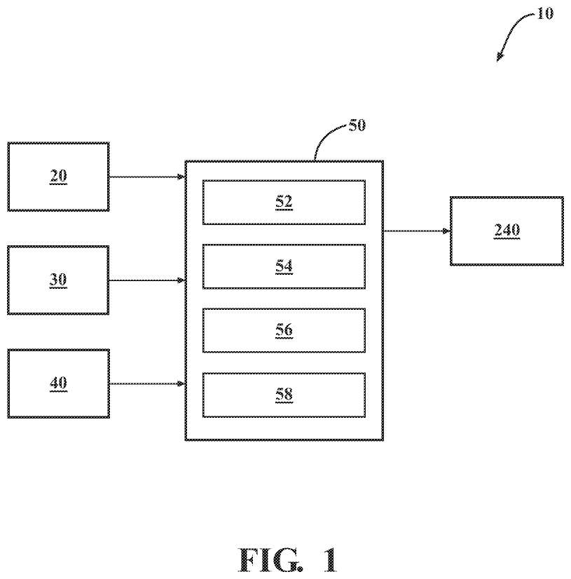

FIG. 1 schematically illustrates an exemplary data flow 10 useful to project a ground surface and perform tracking-based state error correction. The data flow 10 includes programming operated within a computerized device within a host vehicle. The data flow 10 is illustrated including three perception inputs, a camera device 20, a LIDAR sensor 30, and an electronic control unit 40. These perception inputs provide data to an object detection and localization module 50. The object detection and localization module 50 processes the perception inputs and provides information according to the disclosed methods to a vehicle control unit 240. Vehicle control unit 240 is a computerized device useful to navigate the vehicle based upon available information including the output of the object detection and localization module 50.

The object detection and localization module 50 includes a plurality of computational steps that are performed upon the perception inputs to generate the output of the disclosed methods. These computational steps are illustrated by a vision-based object detection and localization module 52, a ground surface estimation and projection module 54, a transform in world coordinate module 56, and a tracking-based state error correction module 58. The vision-based object detection and localization module 52 includes computerized programming to input and analyze data from the camera device 20. The vision-based object detection and localization module 52 performs image recognition processes upon image data from the camera device 20 to estimate identities, distance, pose, and other relevant information about objects in the image data.

The ground surface estimation and projection module 54 includes computerized programming to input and analyze data from the LIDAR device 30. Data from the LIDAR device 30 includes a plurality of points representing signal returns to the LIDAR device 30 representing samples of the ground surface in an operating environment of the host vehicle. This plurality of points may be described as an entire point cloud collected by the LIDAR device 30. According to methods disclosed herein, the ground surface estimation and projection module 54 segments the entire point cloud and identifies portions of the point cloud that may be utilized to identify a local polygon representing a portion of the ground surface represented by the entire point cloud. By identifying a plurality of local polygons and smoothing a surface represented by the plurality of polygons, the ground surface estimation and projection module 54 may approximate the ground surface represented by the entire point cloud.

The transform in world coordinate module 56 includes computerized programming to input data from the electronic control unit 40 including a three-dimensional coordinate of the host vehicle and digital map database data. The transform in world coordinate module 56 additionally inputs the output of the ground surface estimation and projection module 54. Based upon the data from the electronic control unit 40 and the data from the ground surface estimation and projection module 54, the transform in world coordinate module 56 estimates a corrected ground surface.

The tracking-based state error correction module 58 includes computerized programming to process the corrected ground surface provided by the transform in world coordinate module 56 and the estimated objects provided by the vision-based object detection and localization module 52. The tracking-based state error correction module 58 may combine the input data to estimate locations of the estimated objects upon the corrected ground surface. An estimated location of an object upon the corrected ground surface may be described as object localization, providing an improved estimate of the location and pose of the estimated object.

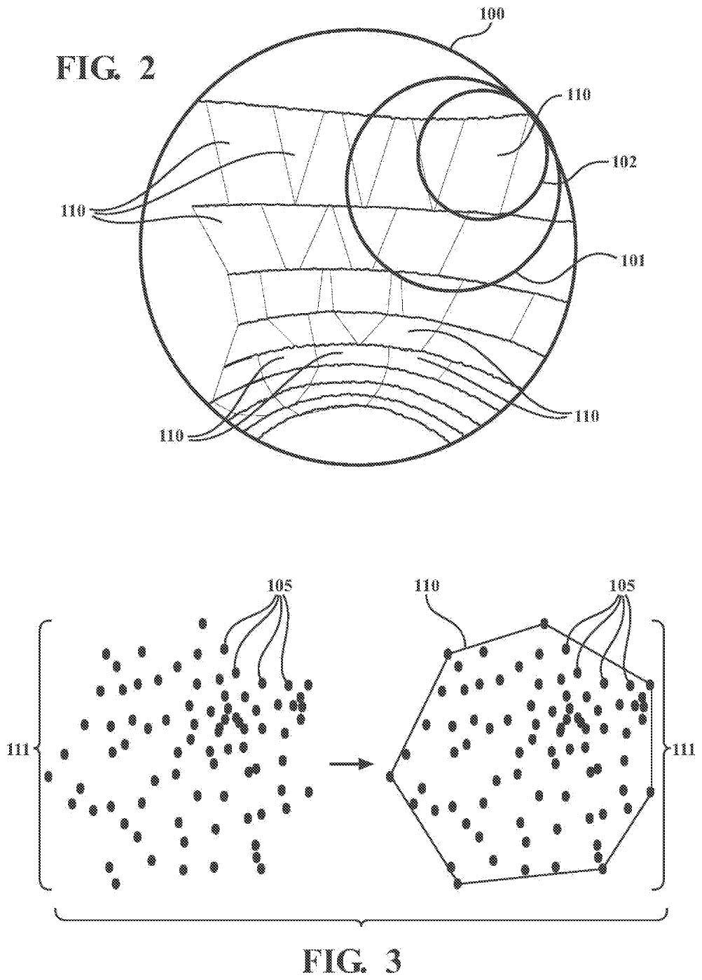

FIG. 2 illustrates an exemplary actual ground surface detected by a host vehicle divided into smaller portions. An area representing an actual ground surface is illustrated, where a circle 100 represents an overall area over which a total point cloud is collected. The total point cloud includes a plurality of points representing signal returns monitored and provided by a LIDAR device and collectively describe the actual ground surface 108. However, interpreting the entire ground surface at once in real-time is computationally prohibitive and may lead to inaccurate surface estimations. For example, if a portion of the road surface is obscured, shadowy, or includes a rough surface, a single, overall estimation of the actual ground surface may be inaccurate. FIG. 2 illustrates a circle 101 representing a portion of the overall circle 100 representing a segment of the total point cloud. In analyzing the circle 101 and points that fall within circle 101, a local point cloud may be identified and analyzed to attempt to define a local polygon based upon the points within the circle 101. However, in the example of FIG. 2, the points within the circle 101 are not consistent enough to define a local polygon. As a result, a smaller circle 102 may be defined. In the example of FIG. 2, the points within the circle 102 are consistent enough to define a local polygon 110 representing a portion of the actual ground surface 108 represented by points within the circle 102. A plurality of local polygons 110 are illustrated which may be combined together to describe a total estimated ground surface. By segmenting the total point cloud into local point clouds and estimating local polygons 110 based upon the local point clouds, an overall computational load of the ground estimation may be minimized and accuracy of the total estimated ground surface may be improved.

FIG. 3 illustrates an exemplary cluster of points or a segmented point cloud representing a portion of a global point cloud provided by LIDAR sensor data and illustrates the segmented point cloud being defined as a group to a local polygon. On a left side of FIG. 3, a local point cloud 111 including a segment of a total point cloud is illustrated including a plurality of points 105. On a right side of FIG. 3, the local point cloud 111 including the plurality of points 105 is illustrating where a local polygon 110 is defined based upon the local point cloud 111.

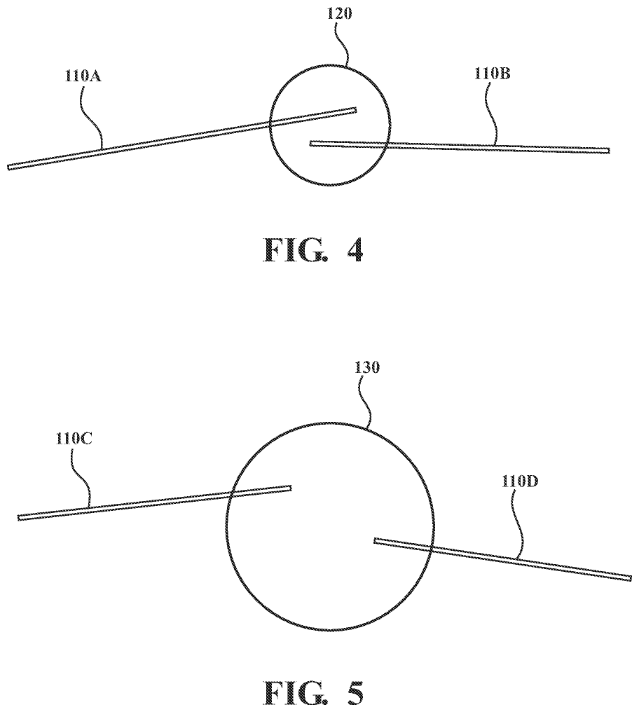

FIG. 4 illustrates in edge view a first local polygon 110A and a second local polygon 110B, with the two polygons overlapping. The first local polygon 110A overlaps the second local polygon 110B in an overlap area 120. FIG. 5 illustrates in edge view a third local polygon 110C and a fourth local polygon 110D, with the two polygons stopping short of each other with a gap existing therebetween. The third local polygon 110C stops short of the fourth local polygon 110D in a gap area 130.

The computerized device within a host vehicle employing the method disclosed herein may employ programming to smooth or average transitions between the local polygons 110 such as the overlap area 120 and the gap area 130.

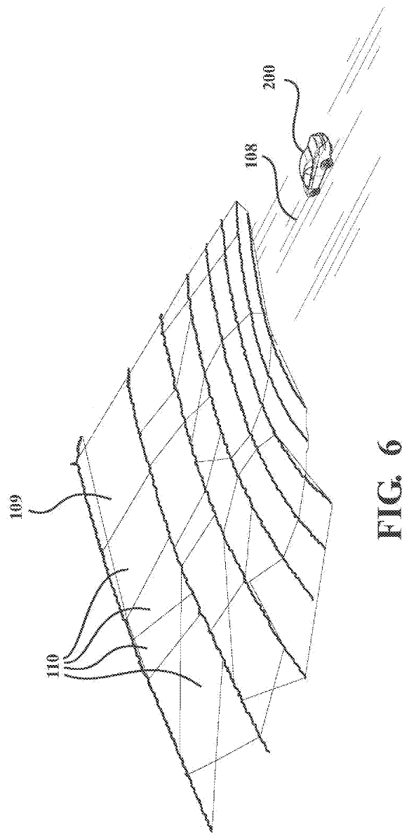

FIG. 6 illustrates a plurality of local polygons 110 combined together into a total estimated ground surface 109. A host vehicle 200 is illustrated upon the actual ground surface 108. The local polygons 110 and the total estimated ground surface 109 are overlaid upon the actual ground surface 108, showing how data from a LIDAR device upon the host vehicle 200 may be utilized to generate the total estimated ground surface 109 to estimate the actual ground surface 108.

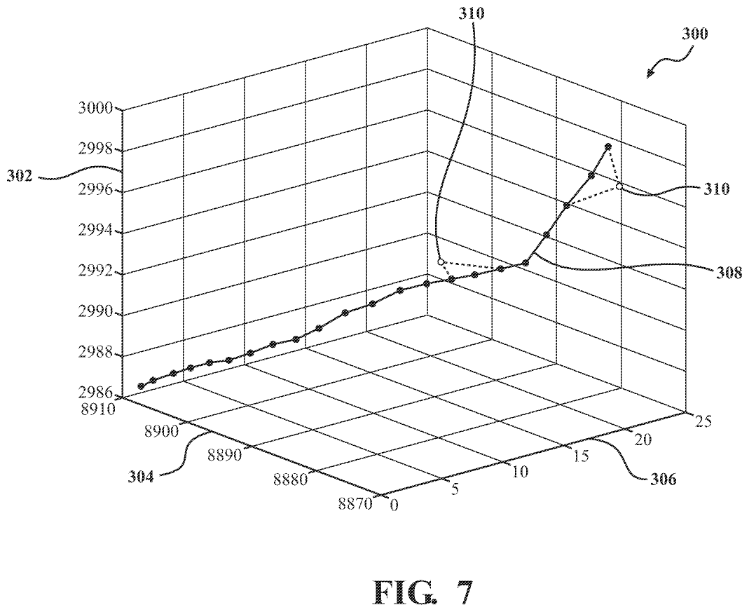

FIG. 7 graphically illustrates a vehicle pose correction over time. A graph 300 is provided showing vehicle pose correction of a tracked object over time utilizing the methods disclosed herein. The graph 300 includes a first axis 302 providing an object coordinate x-coordinate. The graph 300 further includes a second axis 304 providing an object coordinate y-coordinate. The graph 300 further includes a third axis 306 providing a time value over a sample period. A plot 308 includes a plurality of points showing vehicle pose corrections over time, wherein the plurality of points is spaced at equal time increments through the sample time period. Two points 310 are illustrated showing outliers that may be filtered out of the tracking of the object. The points sampled may be filtered or analyzed for an overall trend through methods in the art, and the two points 310 may be removed and not factored in the determination of the plot 308.

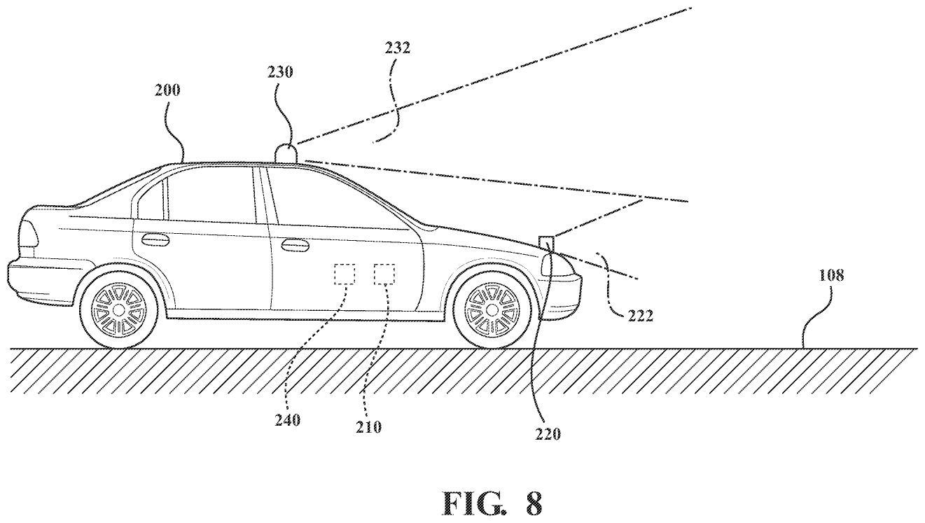

FIG. 8 schematically illustrates an exemplary host vehicle 200 upon an actual ground surface 108 including the disclosed systems. The host vehicle 200 is illustrated including a computerized device 210 operating programming according to the methods disclosed herein. The host vehicle 200 further includes a camera device 220 providing data collected through a point of view 222, a LIDAR device 230 providing data collecting data regarding actual ground surface 108 through a point of view 232, and a computerized vehicle control unit 240 which provides control over navigation of the host vehicle 200 and includes data including operational information about the host vehicle 200, three-dimensional vehicle location data of the host vehicle 200, and digital map database information. The computerized device 210 is in electronic communication with the camera device 220, the LIDAR device 230, and the vehicle control unit 240. The computerized device 210 operates programming according to the disclosed methods, utilizes data collected through the various connected devices, and provides estimated ground surface data and corrected object tracking data to the vehicle control unit 240 for use in creating and updating a navigational route for the host vehicle 200.

The computerized device and the vehicle control unit may each include a computerized processor, random-access memory (RAM), and durable memory storage such as a hard drive and/or flash memory. Each may include one or may span more than one physical device. Each may include an operating system and is operable to execute programmed operations in accordance with the disclosed methods. In one embodiment the computerized device and the vehicle control unit represent programmed methods operated by programming within a single device.

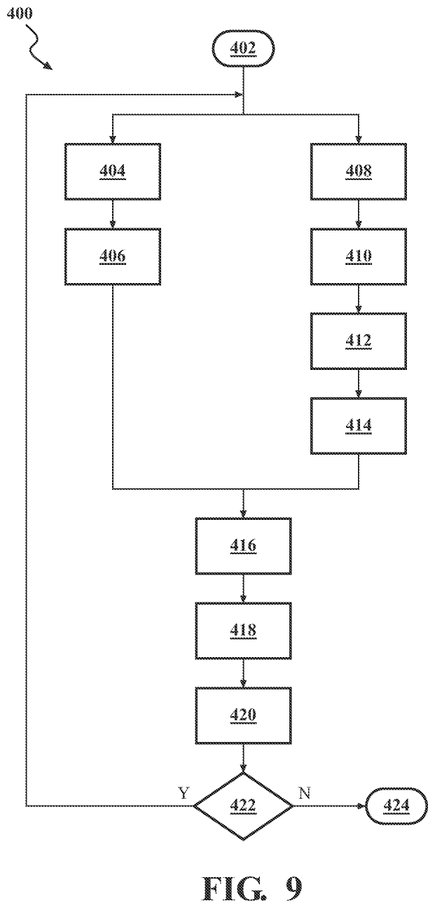

FIG. 9 is a flowchart illustrating an exemplary method 400 for object localization using ground surface projection and tracking-based prediction for autonomous driving. The method 400 is operated by programming within a computerized device of a host vehicle. The method 400 starts as step 402. At step 404, camera device data is analyzed and an object in an operating environment of the host vehicle is identified. At step 406, a position and pose of the object is tracked. At step 408, LIDAR data providing information about an actual ground surface including a total point cloud is monitored. At step 410, the total point cloud is segmented into a plurality of local point clouds. At step 412, each of the local point clouds is utilized to define a local polygon. At step 414, the plurality of local polygons is assembled and smoothed into a total estimated ground surface. At step 416, the total estimated ground surface is compared to three-dimensional coordinates and digital map data, transforming the total estimated ground surface into in world coordinates. At step 418, tracking-based state error correction of the tracked object is performed to locate and localize the tracked object to the total estimated ground surface. At step 420, information regarding the tracked object and the total estimated ground surface is utilized to navigate the host vehicle, for example, to travel over the actual ground surface and avoid conflict with the tracked object. At step 422, a determination is made whether the host vehicle is continuing to navigate. If the host vehicle is continuing to navigate, the method 400 returns to steps 404 and 408. If the host vehicle is not continuing to navigate, the method 400 proceeds to step 424 where the method ends. Method 400 is provided as an example of how the methods disclosed herein may be operated. A number of additional or alternative method steps are envisioned, and the disclosure is not intended to be limited to the examples provided herein.

While the best modes for carrying out the disclosure have been described in detail, those familiar with the art to which this disclosure relates will recognize various alternative designs and embodiments for practicing the disclosure within the scope of the appended claims.

What is claimed is:

1. A system for ground surface projection for autonomous driving of a host vehicle, comprising:
a LIDAR device of the host vehicle;
a computerized device, operable to:
monitor data from the LIDAR device including a total point cloud, wherein the total point cloud describes an actual ground surface in an operating environment of the host vehicle;
segment the total point cloud into a plurality of local point clouds;
for each of the local point clouds, determine a local polygon estimating a portion of the actual ground surface;
assemble the local polygons into a total estimated ground surface; and
navigate the host vehicle based upon the total estimated ground surface.

2. The system of claim 1, further comprising a camera device of the host vehicle; and
wherein the computerized device is further operable to:
monitor data from the camera device;
identify and track an object in an operating environment of the host vehicle based upon the data from the camera device;
determine a location of the object upon the total estimated ground surface; and
navigate the host vehicle further based upon the location of the object upon the total estimated ground surface.

3. The system of claim 1, wherein the computerized device is further operable to smooth transitions in the total estimated ground surface between the local polygons.

4. The system of claim 3, wherein smoothing the transitions in the total estimated ground surface between the local polygons includes smoothing overlaps in the local polygons.

5. The system of claim 3, wherein smoothing the transitions in the total estimated ground surface between the local polygons includes smoothing gaps in the local polygons.

6. The system of claim 1, wherein the computerized device is further operable to:
monitor three-dimensional coordinates of the host vehicle;
monitor digital map data; and
transform the total estimated ground surface into in world coordinates based upon the three-dimensional coordinates and the digital map data.

7. The system of claim 1, wherein determining the local polygon estimating the portion of the actual ground surface includes determining a normal vector angle for each local polygon; and
wherein the normal vector angle for each polygon is utilized to map the total estimated ground surface.

8. A system for ground surface projection for autonomous driving of a host vehicle, comprising:
a camera device of the host vehicle;
a LIDAR device of the host vehicle;
a computerized device, operable to:
monitor data from the camera device;
identify and track an object in an operating environment of the host vehicle based upon the data from the camera device;
monitor data from the LIDAR device including a total point cloud, wherein the total point cloud describes an actual ground surface in the operating environment of the host vehicle;
segment the total point cloud into a plurality of local point clouds;
for each of the local point clouds, determine a local polygon estimating a portion of the actual ground surface;
assemble the local polygons into a total estimated ground surface;
determine a location of the object upon the total estimated ground surface; and
navigate the host vehicle based upon the total estimated ground surface and the location of the object upon the total estimated ground surface.

9. The system of claim 8, wherein the computerized device is further operable to smooth transitions in the total estimated ground surface between the local polygons.

10. The system of claim 9, wherein smoothing the transitions in the total estimated ground surface between the local polygons includes smoothing overlaps in the local polygons.

11. The system of claim 9, wherein smoothing the transitions in the total estimated ground surface between the local polygons includes smoothing gaps in the local polygons.

12. A method for ground surface projection for autonomous driving of a host vehicle, comprising:
within a computerized processor within the host vehicle,
monitoring data from a LIDAR device upon the host vehicle including a total point cloud, wherein the total point cloud describes an actual ground surface in an operating environment of the host vehicle;
segmenting the total point cloud into a plurality of local point clouds;
for each of the local point clouds, determining a local polygon estimating a portion of the actual ground surface;
assembling the local polygons into a total estimated ground surface; and
navigating the host vehicle based upon the total estimated ground surface.

13. The method of claim 12, further comprising, within the computerized processor, monitoring data from a camera device upon the host vehicle;
identifying and tracking an object in an operating environment of the host vehicle based upon the data from the camera device;
determining a location of the object upon the total estimated ground surface; and
navigating the host vehicle further based upon the location of the object upon the total estimated ground surface.

14. The method of claim 12, further comprising, within the computerized processor, smoothing transitions in the total estimated ground surface between the local polygons.

15. The method of claim 14, wherein smoothing the transitions in the total estimated ground surface between the local polygons includes smoothing overlaps in the local polygons.

16. The method of claim 14, wherein smoothing the transitions in the total estimated ground surface between the local polygons includes smoothing gaps in the local polygons.

17. The method of claim 12, further comprising, within the computerized processor,
monitoring three-dimensional coordinates of the host vehicle;
monitoring digital map data; and
transforming the total estimated ground surface into in world coordinates based upon the three-dimensional coordinates and the digital map data.

18. The method of claim 12, wherein determining the local polygon estimating the portion of the actual ground surface includes determining a normal vector angle for each local polygon; and
further comprising, within the computerized processor, utilizing the normal vector angle for each polygon to map the total estimated ground surface.
